(19) United States
(12) Patent Application Publication
(10) Pub. No.: US 2018/0349948 A1
(43) Pub. Date: Dec. 6, 2018

(54) EVALUATION OF EFFECTIVENESS OF SIGNS

(71) Applicant: International Business Machines Corporation, Armonk, NY (US)

(72) Inventors: Eli M. Dow, Wappingers Falls, NY (US); Thomas D. Fitzsimmons, Lancaster, PA (US); Jessie Yu, Wappingers Falls, NY (US)

(21) Appl. No.: 15/608,235

(22) Filed: May 30, 2017

(51) Int. Cl. G06Q 30/02; G09F 7/14; G09F 27/00

(52) U.S. Cl. CPC G06Q 30/0246; G06Q 30/0261; G09F 27/005; G06Q 30/0244; G09F 7/14

(57) ABSTRACT

An embodiment of a method of evaluating an effectiveness of a sign includes detecting whether a user is within a selected range of a location of a sign, and based on the user being within the selected range, acquiring a visible image of the user. The method also includes estimating, by a gaze monitoring device, a direction of a gaze of the user, and determining whether the estimated direction of the gaze is toward the location. The method further includes, based on determining that the gaze is toward the location, performing, by a processing device, estimating an amount of time during which the estimated direction of the gaze is toward the location, and based on the amount of time being greater than or equal to a threshold amount, determining that the user has at least a threshold level of interest in the sign.

### BACKGROUND

The present invention relates generally to analysis of sign and advertising effectiveness, and more specifically, to determining an interest level and/or demographic information of a user exposed to a sign.

Road signs and visual advertising along roadways are common mechanisms for visually communicating with vehicle drivers and passengers. One challenge with such mechanisms is the lack of an ability to accurately judge the effectiveness of signs and advertisements. For example, it can be difficult to determine whether and which persons pay attention to signs (e.g., billboards), and how effective such signs are in conveying information and/or contributing to product sales.

### SUMMARY

An embodiment of a method of evaluating an effectiveness of a sign includes detecting whether a user is within a selected range of a location of a sign and based on the user being within the selected range, acquiring a visible image of the user. The method also includes estimating, by a gaze monitoring device, a direction of a gaze of the user, and determining whether the estimated direction of the gaze is toward the location. The method further includes, based on determining that the gaze is toward the location, performing, by a processing device, estimating an amount of time during which the estimated direction of the gaze is toward the location, and based on the amount of time being greater than or equal to a threshold amount, determining that the user has at least a threshold level of interest in the sign.

An embodiment of an apparatus for evaluating an effectiveness of a sign includes a location module configured to detect whether a user is within a selected range of a location of a sign, and a gaze monitoring device configured to, based on the user being within the selected range, acquire a visible image of the user, estimate a direction of a gaze of the user, and determine whether the estimated direction of the gaze is toward the location. The apparatus also includes a processing device configured to, based on determining that the gaze is toward the location, estimate an amount of time during which the estimated direction of the gaze is toward the location, and based on the amount of time being greater than or equal to a threshold amount, determine that the user has at least a threshold level of interest in the sign.

An embodiment of a computer program product for evaluating an effectiveness of a sign includes a computer readable storage medium having program instructions embodied therewith, wherein the computer readable storage medium is not a signal, the program instructions readable by a processing circuit to cause the processing circuit to perform a method. The method includes detecting whether a user is within a selected range of a location of a sign and based on the user being within the selected range, acquiring a visible image of the user. The method also includes estimating, by a gaze monitoring device, a direction of a gaze of the user, and determining whether the estimated direction of the gaze is toward the location. The method further includes, based on determining that the gaze is toward the location, estimating an amount of time during which the estimated direction of the gaze is toward the location, and based on the amount of time being greater than or equal to a threshold amount, determining that the user has at least a threshold level of interest in the sign.

### BRIEF DESCRIPTION OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 depicts a processing device in accordance with an embodiment;

FIG. 2 depicts an example of a processing environment in which a processing device may be used to perform embodiments described herein; and

FIG. 3 is a flow diagram depicting an embodiment of a method of detecting and evaluating attention to and the effectiveness of signs and other visual communications.

### DETAILED DESCRIPTION

Apparatuses, systems, and methods are provided for detecting and evaluating attention to and the effectiveness of signs and other visual communications. An embodiment of a system is configured to determine a proximity of a user to a sign and/or whether the user is within a selected range of the sign, and detect whether the user is observing or looking at the sign based on facial detection. In one embodiment, detection of whether the user is observing the sign is based on estimating an orientation of the gaze of the user and/or a vehicle in which the user is located.

In one embodiment, the system is configured to collect demographic information about the user in response to determining that the user has an interest in the sign, and may be configured to analyze the demographics information to determine the effectiveness of the sign. The demographic information may be collected automatically in response to determining that the user is interested in the information being conveyed by the sign, i.e., has a level of interest that is greater than or equal to some threshold level of interest. The level of interest may be estimated based on an amount of time during which the user is observing the sign and/or whether the user's gaze is tracking the sign.

Information regarding user interest and demographics can be automatically stored and/or used for analysis regarding the effectiveness of the sign. For example, the information regarding which and how many users pay attention to the sign can be used in conjunction with other sales and/or marketing data to track users from exposure to the sign through purchasing of advertised products and services. The attention information and/or demographic analysis may be used to develop, e.g., advertising and marketing strategies.

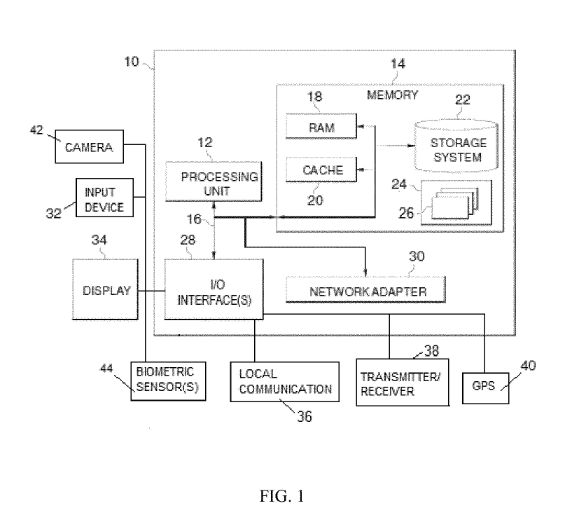

FIG. 1 illustrates an example of a computing device 10 that can be used to perform various actions, including receiving and processing user inputs and performing various processing actions as described herein, including storing and processing data, executing programs and displaying information. The device 10 may be configured to receive or gather communications (e.g., data, text, spoken words, emails, authentication information, etc.) from other locations, such as a network (e.g., Internet) and/or another processor (e.g., server, computer or mobile device). The device 10 may be any device capable of receiving input from users, sensors and/or other devices, performing processing actions and displaying text and other information to a user. Examples of the device 10 include as a mobile device (e.g., a smartphone), a wearable device (e.g., a smartwatch), a tablet computer, a laptop computer, a desktop computer, a mainframe a server and others.

The device 10 includes various components and/or modules for performing various processing, sensing and display functions. The device 10 includes one or more processors or processing units 12, a memory 14, and a bus 16 that couples various components including the memory 14 to the processor 12.

The memory 14 includes computer readable media in the form of volatile memory, such as random access memory (RAM) 18 and/or cache memory 20. The device 10 may also include other removable/non-removable, volatile/non-volatile computer system storage media. For example, the memory 14 includes storage 22 including a non-removable, non-volatile magnetic media (e.g., a hard drive), and/or removable storage media such as a memory card or flash drive. The memory 14 may include at least one program product having a set (e.g., at least one) of program modules that are configured to carry out the functions of embodiments described herein. For example, the memory 14 stores a program or utility suite 24 including one or more program modules 26 to carry out the functions and/or methodologies of embodiments described herein. The program 24 and/or program modules 26, in one embodiment, are configured as an application for evaluating the effectiveness of signs as described further herein. The application can be embodied as, e.g., a computer program, an on-board vehicle program, and/or a smartphone or tablet application (“app”).

The device 10 includes or is connected to various components, which may be incorporated in the device 10 or external to the device 10. The device 10 includes interfaces 28 for communication with components and may also include a network adapter 30 (e.g., a 3G/4G modem) for communication with other devices or components over a suitable network or remote connection. The device 10 may be connected to or may include at least one input device 32 such as a touchscreen, keyboard, button and/or mouse, and a display 34. The input device 32 can be incorporated with the display 34, e.g., as a touchscreen. The components shown in FIG. 1 and described herein are provided for illustrative purposes and are not intended to be limiting.

The device 10 includes components for local and/or remote communication. In one embodiment, the device 10 includes a wireless communication device 36 such as an antenna assembly for transmitting and receiving local communications, such as Bluetooth, Wi-Fi and/or near field communication (NFC) components. Local communications are distinguished from remote communications, by which communication is over a remote network such as a cellular network or Internet communications. Local communications include communication protocols and techniques such as Bluetooth, local Wi-Fi communications (e.g., between devices with range of a Wi-Fi hotspot or signal source). The device 10 may also include a remote communication device 38 such as a cellular or radio transmitter/receiver assembly. The local and/or remote communication devices may be incorporated into a mobile device such a smartphone and/or as part of a vehicle.

The device 10 may also include or be configured to connect to a location device or system, such as a global positioning system (GPS) device 40. Various other components may be incorporated in the device 10. For example, an imaging device such as a camera 42 is incorporated in or connected to the device 10 and is configured to record still images and/or video for use in, e.g., gaze detection processes.

One or more biometric sensors 44 (e.g., a fingerprint sensor, a temperature sensor, a heart rate sensor, a capacitive sensor, a thermal imaging device, etc.) can be used for recording biometric characteristics such as fingerprints, vital signs and others.

A system including the device 10 or aspects thereof is configured to evaluate the effectiveness of signs based on detection of a user's location and a direction of a user's gaze. As described herein, a “sign” is defined as any visual and/or audible display or notification designed to impart information to an observer. Examples of signs include billboards and other advertisements, road signs, informational notices and others. Signs may be located within visible range of a road, walkway, train track, marine vessel route or other location designed to be observable by a user. Although embodiments are described herein in the context of billboards or other road-side displays, they are not so limited.

In one embodiment, the system is configured to evaluate the effectiveness of a sign based on various metrics, such as whether a person or user has looked toward the sign, and a level of interest based on how long the user looks at the sign and/or whether the user is tracking the sign during travel. Other metrics of effectiveness include a demographic profile of the user to determine whether the user is within a population that is targeted by the sign. Information regarding each user can be transmitted or input to a marketing analytics system that may track individual users and/or assess multiple users to determine whether the targeted population is interested in the sign. For example, information regarding a level of interest by a user in combination with demographic information can be used to estimate how effectively the signs draws attention from targeted populations. Marketing analytics can also evaluate the effectiveness by determining whether the user has purchased an advertised product or service and/or whether the user has expressed further interest by, e.g., searching the internet for an advertised product or service.

In one embodiment, the system is configured to determine whether a user is looking at a sign and/or estimate a level of interest based on a gaze detection process. The gaze detection process includes acquiring video, a series of still images or other visual imaging, and estimate a direction of a user's gaze. The direction may be estimated by determining gaze direction relative to a camera (e.g., in a smartphone or mounted on a vehicle dashboard), in combination with an orientation of a vehicle. A level of interest may be based on the amount of time during which the user's gaze is directed toward the sign, and/or by tracking changes in gaze direction to determine if the user is tracking the sign as the user and/or vehicle is moving.

Based on the system determining that the user is looking at the sign and/or determining that the user exhibits a selected level of interest, various demographic information may be collected. Examples of such information include height, weight, age, gender and health status. If the user is traveling in a vehicle, the demographic information may include economic information about the vehicle, such as make and model, current value, purchase price (e.g., manufacturer's suggested retail price or MSRP), age of the vehicle, maintenance information and others. The demographic information can be transmitted or input to a marketing analytics system that can evaluate the effectiveness of the sign, e.g., based on whether a target population expresses interest, a level of interest of the target population, and subsequent user behavior (e.g., whether the user performs for research and/or purchases an advertised product or service).

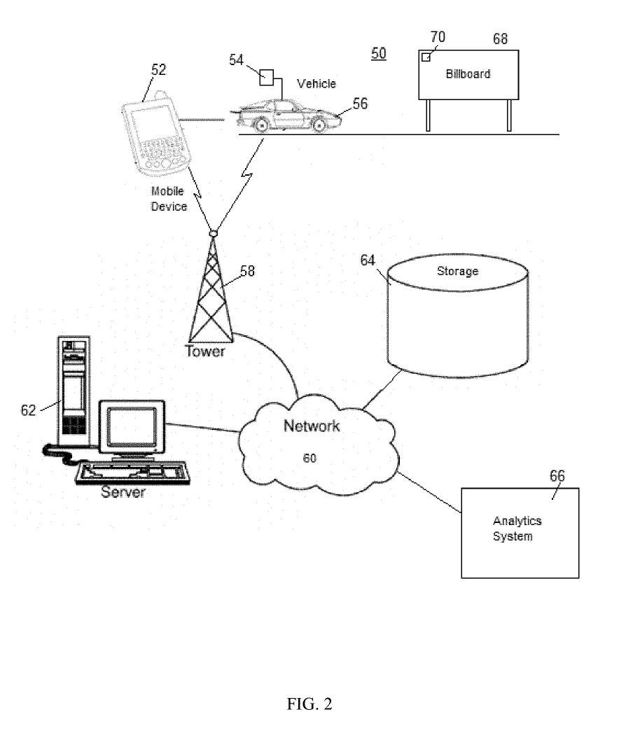

FIG. 2 illustrates an operating environment 50 in which the device 10 can be operated to perform the various methods and embodiments described herein. In this embodiment, the device 10 is an on-board vehicle processor, a smartphone or other mobile device, or any other suitable processing device. The device is configured to detect when a vehicle is within a selected range of a sign (e.g., billboard), and estimate a level of interest based on gaze detection. The vehicle is described in embodiments as a car or other motor vehicle, but is not so limited. The vehicle may be, e.g., a mass transit vehicle such as a bus or train, or a marine vessel. In addition, embodiments can apply to persons outside of a vehicle, such as pedestrians walking on a sidewalk, through a park or at any other location where signs are visible.

The operating environment includes the processing device 10 configured as or as part of a smartphone 52 and/or an on-board processing device 54 in a vehicle 56. The smartphone 52 and/or the on-board device 54 may include components to communicate over a cellular network via a cellular tower 58, to connect to other devices using telephone communications and/or data links. For example, a network 60 such as the Internet is accessed to communicate with other devices, such as one or more servers 62, and one or more databases 64, which can be used to store data relating to user interest (e.g., gaze detection data) and/or demographic information. In one embodiment, the data can be transmitting to an analytics system 66 for analyzing the user interest and demographic information as discussed further below.

The device 10 is configured to detect a location of a user and/or the vehicle 56 relative to a sign such as a billboard 68. In one embodiment, the processing device 10 can determine the location by accessing location data describing the location of the billboard 68, which may be stored locally by the processing device or can be stored remotely, e.g., in the database 64. The device 10 can track the location of the user and/or the vehicle 56 using GPS data, and detect when the GPS data corresponds with a location within a selected distance, proximity or range of the billboard 68.

In one embodiment, the smartphone 52 and/or the vehicle 56 is equipped with a communication device configured to communicate with a corresponding communication device 70 located at or near the billboard 68. The communication devices may have any suitable configuration for local communication between the communication device 70 and the user and/or vehicle 56. Examples of local communication systems include wireless communication systems such as Bluetooth and other two-way radio communication systems. For example, the billboard 68 can be equipped with a radio-frequency identification (RFID) transponder and the smartphone 52 and/or the vehicle 56 is equipped with a receiver for detecting signals from the transponder.

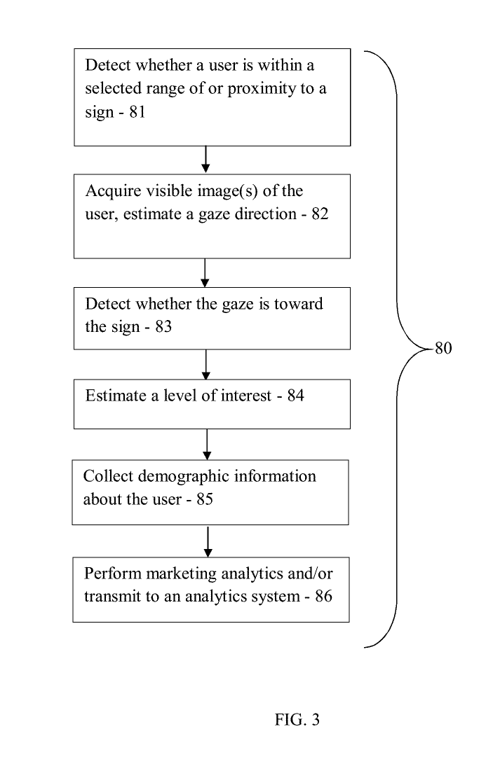

FIG. 3 illustrates embodiments of a method 80 of evaluating the effectiveness of a sign. The method may be performed by a processor or processors disposed in a vehicle (e.g., a car or marine vessel), or disposed in a mobile device, such as a smartphone, tablet, smartwatch etc. For example, the method may be performed by an application stored in the smartphone 52.

The method 80 may be performed using a program suite that includes various processing modules (e.g., program modules 26) configured to perform aspects of the methods described herein. For example, the processing modules can include a location detection module for detecting the location and/or orientation of a user and/or vehicle (e.g., using GPS), and for determining whether the user is within a selected proximity of the sign. The processing modules can also include a gaze detection module (e.g., as part of a gaze detection device) for determining if a user is looking at the sign, how long the user's gaze is toward the sign and/or if the user is tracking the sign. The gaze detection module or another module may be configured to determine whether the user's gaze indicates a selected level of interest.

The method 80 includes a plurality of stages or steps represented by blocks 81-86, all of which can be performed sequentially. However, in some embodiments, one or more of the stages can be performed in a different order than that shown or fewer than the stages shown may be performed.

At block 81, a processing device monitors a user location and detects when the user is within a selected distance from or proximity to a sign. In one embodiment, the monitoring includes comparing the user location to locations of signs stored in the device or remotely (e.g., in a sign location database). Alternatively or in combination with location monitoring, the device can monitor a receiver (e.g., a Bluetooth receiver, radio receiver or RFID communication device) to detect a signal from a sign equipped with a suitable transmitter (e.g., the communication device 70). The monitoring may be performed continuously, periodically, or in response to a detected condition such as entry into a geographic area.

The processing device then determines whether the user is within a selected range of the sign or proximity to the sign. This may be accomplished by determining whether the user's location is within a selected distance using GPS data, or detecting a communication or signal from a device at the sign. The signal may be an analog or digital signal. For example, the signal from the sign may include location information and/or identification information (e.g., sign owner, a description of the advertisement or an identifier). In another example, the device can detect a strength of the signal and determine a distance from the sign based on signal strength.

At block 82, the processing device acquires a visible image or images of the user, e.g., by a camera located at the smartphone or the vehicle. A gaze detection device or module estimates a direction of the user's gaze. The direction, orientation and/or speed of the vehicle may also be acquired by GPS and/or the vehicle speedometer. The gaze detection device can detect the orientation of the camera and the vehicle relative to a reference (e.g., north).

At block 83, the device determines a direction between the user and the sign as a reference direction, and compares the reference direction to the gaze direction. If the reference direction and the gaze direction are the same or at least within a selected tolerance, the device determines that the user's gaze is toward the sign and the user is looking at the sign.

At block 84, the device determines level of interest in the sign by the user. In one embodiment, the level of interest is determined based on an amount of time during which the user is determined to be looking at the sign. The level of interest may be a single level that is detected if the amount of time meets or exceeds a threshold amount, or multiple levels of interest may be determined based on multiple thresholds. For example, if the user glances at the sign or otherwise does not look for at least the threshold amount of time, the device does not determine that the user is interested. However, if the user looks for at least the threshold amount, the user is determined to have at least a threshold level of interest.

The gaze detection module can also assess user movements in estimating a level of interest. In one embodiment, gaze detection module tracks movement of the user's gaze (e.g., eye and/or head movement) to determine whether the user is tracking the location of the sign. Detection of such tracking can indicate that the user is interested or otherwise increase the estimated level of interest.

Other factors can be considered in determining the level of interest. For example, the gaze detection module or another module (e.g., a facial analysis module) can identify facial expressions associated with interest. A facial expression indicative of happiness or excitement (e.g., a smile) can increase the determined level of interest, or a facial expression indicative of anger or a lack of emotion can decrease the level of interest. Other biometric indicators (e.g., heart rate, temperature, etc.) can also be used in determining the level of interest. In some instances, the device can collect and store this information even if a threshold level of interest is not met, which could be useful in analyzing the sign's effectiveness.

At block 85, in response to estimating that the user has at least a threshold level of interest, the device collects demographic information about the user. Demographic information may be any type of information that can be helpful in classifying the user as part of some demographic group (e.g., men or women, different age groups, different levels of income, or combinations thereof). Examples of demographic information include age, gender, height, weight, geographical residence, political affiliation, socio-economic class and others.

For example, information such as age, height and weight can be inferred from images of the user and/or from biometric measurements. Examples of biometric measurements include fingerprint measurements, temperature measurements, and heart rate measurements that can be analyzed to infer characteristics of the user such as age, weight, gender and health. Such data can be collected via any suitable device or system, such as a fingerprint sensor and/or other biometric sensors on the smartphone, worn on the user, or in the vehicle (e.g., a fingerprint and/or biometric sensor on the vehicle's steering wheel).

The demographic information may include economic information. For example, the device can collect data regarding the vehicle make and model, age of the vehicle, vehicle price (e.g., MSRP or used value), maintenance history and others. The data can be accessed via the on-board system, from user inputs and/or from accessing other sources of information such as databases and websites.

In one embodiment, in response to determining that the user exhibits at least the threshold level of interest, the device can access or receive data that can be displayed to the user or otherwise provided to give the user more information and/or provide incentives. For example, if the sign is advertising a product such as a vehicle, the device can request or access data relating to dealers in the area that are selling the vehicle, product information, pricing information and/or any other suitable information regarding the product.

At block 86, data including the level of interest, user identification information and/or the demographic information can be used in a marketing analytics process that determines information relating to the effectiveness of the sign in attracting the interest of a group targeted by the sign.

The level of interest and demographic information can be used by the marketing analytics in various ways to assess the effectiveness of the sign. For example, the analytics module can determine the number or percentage of interested users that fall into a selected demographic population or classification. Additional information can be used to assess the effectiveness, such as data regarding whether the user accessed further information (e.g., by visiting associated websites) and whether the user purchased an advertised product or service.

Although the method 80 describes collecting information regarding interested users, the method is not so limited. For example, data regarding the total number of users that come within a proximity of the sign can be collected, and/or data regarding users that do not exhibit the threshold level of interest can be collected and stored or transmitted for analysis. This data can be useful in providing a more complete picture of the impact that the sign has on different groups or classification, which can further aid in assessing the effectiveness of the sign.

Technical effects and benefits include the ability to automatically detect if a user is looking at a sign and estimate a level of interest to, e.g., provide advertisers information regarding the effectiveness of an advertisement. In addition, the determination of whether a user looks at a sign and/or is interested in a sign, as well as the collection of demographic information, can be performed without requiring active participation by or interaction with the user. Information collected using the embodiments described herein can be used to plan marketing strategies, design advertisements and/or locate advertisements to improve exposure to targeted audiences.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of evaluating an effectiveness of a sign, the method comprising:
detecting whether a user is within a selected range of a location of a sign;
based on the user being within the selected range, acquiring a visible image of the user;
estimating, by a gaze monitoring device, a direction of a gaze of the user;
determining whether the estimated direction of the gaze is toward the location; and
based on determining that the gaze is toward the location, performing, by a processing device:
estimating an amount of time during which the estimated direction of the gaze is toward the location; and
based on the amount of time being greater than or equal to a threshold amount, determining that the user has at least a threshold level of interest in the sign.

2. The method of claim 1, wherein the user is located in a vehicle, and estimating the direction is based on estimating an orientation of the gaze relative to the gaze monitoring device, and estimating an orientation of the vehicle relative to the sign.

3. The method of claim 2, further comprising detecting whether the gaze is tracking the location.

4. The method of claim 1, further comprising automatically collecting and storing demographic information describing the user based on determining that the user has at least the threshold level of interest.

5. The method of claim 4, wherein the user is located in a vehicle, and the demographic information includes vehicle information including at least one of a vehicle make, a vehicle model, a vehicle value and vehicle maintenance information.

6. The method of claim 4, wherein collecting the demographic information includes performing a biometric measurement of the user.

7. The method of claim 4, further comprising transmitting the demographic information to a marketing analytics system configured to evaluate an effectiveness of the sign based on the demographic information.

8. An apparatus for evaluating an effectiveness of a sign, the apparatus comprising:
a location module configured to detect whether a user is within a selected range of a location of a sign;
a gaze monitoring device configured to, based on the user being within the selected range, acquire a visible image of the user, estimate a direction of a gaze of the user, and determine whether the estimated direction of the gaze is toward the location; and
a processing device configured to, based on determining that the gaze is toward the location:
estimate an amount of time during which the estimated direction of the gaze is toward the location; and
based on the amount of time being greater than or equal to a threshold amount, determine that the user has at least a threshold level of interest in the sign.

9. The apparatus of claim 8, wherein the user is located in a vehicle, and the gaze monitoring device is configured to estimate the direction is based on an orientation of the gaze relative to the gaze monitoring device, and an orientation of the vehicle relative to the sign.

10. The apparatus of claim 8, wherein the gaze monitoring device is configured to detect whether the gaze is tracking the location.

11. The apparatus of claim 8, wherein the processing device is configured to automatically collect and store demographic information describing the user based on determining that the user has at least the threshold level of interest.

12. The apparatus of claim 11, wherein the user is located in a vehicle, and the demographic information includes vehicle information including at least one of a vehicle make, a vehicle model, a vehicle value and vehicle maintenance information.

13. The apparatus of claim 11, wherein the demographic information includes a biometric measurement of the user.

14. The apparatus of claim 11, wherein the processing device is configured to transmit the demographic information to a marketing analytics system configured to evaluate an effectiveness of the sign based on the demographic information.

15. A computer program product for evaluating an effectiveness of a sign, the computer program product comprising:
a computer readable storage medium having program instructions embodied therewith, wherein the computer readable storage medium is not a signal, the program instructions readable by a processing circuit to cause the processing circuit to perform a method comprising:
detecting whether a user is within a selected range of a location of a sign;
based on the user being within the selected range, acquiring a visible image of the user;
estimating, by a gaze monitoring device, a direction of a gaze of the user;
determining whether the estimated direction of the gaze is toward the location;
based on determining that the gaze is toward the location, estimating an amount of time during which the estimated direction of the gaze is toward the location; and
based on the amount of time being greater than or equal to a threshold amount, determining that the user has at least a threshold level of interest in the sign.

16. The computer program product of claim 15, wherein the user is located in a vehicle, and estimating the direction is based on estimating an orientation of the gaze relative to the gaze monitoring device, and estimating an orientation of the vehicle relative to the sign.

17. The computer program product of claim 15, wherein the method further comprises automatically collecting and storing demographic information describing the user based on determining that the user has at least the threshold level of interest.

18. The computer program product of claim 17, wherein the user is located in a vehicle, and the demographic information includes vehicle information including at least one of a vehicle make, a vehicle model, a vehicle value and vehicle maintenance information.

19. The computer program product of claim 17, wherein the demographic information includes a biometric measurement of the user.

20. The computer program product of claim 17, wherein the method further comprises transmitting the demographic information to a marketing analytics system configured to evaluate an effectiveness of the sign based on the demographic information.
